(19) United States
(12) Patent Application Publication
(10) Pub. No.: US 2009/0223118 A1
(43) Pub. Date: Sep. 10, 2009

(54) Method and Apparatus for Manufacturing and Purifying Bio-Diesel

(75) Inventors: Michael Everton, Berwick (AU); David West McKenzie, Kansas City, MO (US); Steven Scott McGuire, Woodlands, TX (US)

Correspondence Address: STANDLEY LAW GROUP LLP, 6300 Riverside Drive, Dublin, OH, 43017, US

(73) Assignee: ACQUA INTERNATIONAL GROUP INC, Toorak, VI (AU)

(21) Appl. No.: 12/095,872

(22) PCT Filed: Dec. 1, 2006
(86) PCT No.: PCT/AU06/01827

§ 371 Date: Dec. 12, 2008

Related U.S. Application Data
(60) Provisional application No. 60/597,444, filed on Dec. 2, 2005.

(51) Int. Cl. C10L 1/18; B01J 19/00

(52) U.S. Cl. 44/308; 422/189

(57) ABSTRACT

A process for producing bio-diesel is described in which a consolidator in the form of a hydrocyclone is located between the processor or reactor and a separator to improve the efficiency of the overall formation of bio-diesel. The present of the consolidator in which the major constituents of the bio-diesel is in one part or in one flow both within the consolidator and the by-products are in another part of flowpath within the consolidator acts to condition the mixture from the processor so that more efficient separation can take place in the separator thereby reducing the time taken to achieve separation of the bio-diesel component from the by-product.

### FIELD OF THE INVENTION

The present invention relates to processes and apparatus for the manufacture of bio-diesel or bio-diesel components and to the decontamination of the bio-diesel or bio-diesel component by removing contaminants, including residual contaminants produced in the reaction forming the bio-diesel or component from which the bio-diesel is formed.

In one aspect the present invention relates to methods and apparatus for producing alkyl esters, particularly fatty acid alkyl esters, such as fatty acid ethyl esters, fatty acid methyl esters or the like, particularly of the type that can be used as a fuel including a diesel fuel, a bio-diesel fuel or similar fuel for engines, such as the engines of motor vehicles in which waste material containing fats, oils and greases, particularly waste vegetable oils and/or fats and oils from animal origin are transesterified to form the fatty acid alkyl esters, more commonly referred to as esters or bio-diesel in this specification depending upon the extent of treatment to remove the decontamination from the esters.

In another aspect of the invention the process includes not only making the fatty acid alkyl esters but also decontaminating the esters by removing any residual by-products such as soap, glycerin, residual catalyst, saponifiables, non-saponifiables, potassium sulphate, or the like that may have formed during the processing and treatment of the waste materials, including during the transesterification reactions.

In one preferred aspect of the invention waste material containing fats, oils and greases optionally including free fatty acid is subject to a transesterification reaction to form the esters and impurities followed by the subsequent removal of the impurities from the esters by various processes to produce a commercially acceptable bio-diesel which can be used as a fuel or as one component of a fuel for engines, particularly engines of motor vehicles including compression engines such as diesel engines, internal combustion engines, hydrogen assisted combustion engines, or the like.

Although the present invention will be described with reference to particular embodiments of the present invention involving transesterification of fatty acids contained in waste materials to form fatty acid methyl esters and the subsequent upgrading or decontamination of the esters to form useable bio-diesel fuels or fuel components using one or more combinations of separation apparatus and reactions, it is to be noted that the scope of the present invention is not limited to the described embodiment or embodiments but rather the scope of the present invention is more extensive so as to include other forms of the transesterification reactions, the use of other materials that can be transesterified to form a fuel or fuel component, other methods and devices for upgrading or decontaminating the bio-diesel fuel or component and other devices, apparatus and processes for treating the contaminants removed from the bio-diesel, and using the bio-diesel or the like.

### BACKGROUND OF THE INVENTION

Apart from the possible exceptions of renewable energy sources such as for example, hydroelectricity, solar power, wind energy and similar, the major part of all energy consumed world wide is derived from petroleum, coal, natural gas or other non-renewable sources. Such sources are limited and will in time be effectively exhausted. Thus, there is a need to provide alternative sources of energy.

The use of waste material to provide energy is attractive not only from a commercial viewpoint but also from an environmental viewpoint. One example of waste materials include fats, oils and greases. Such materials are readily available from a number of sources including being available as waste material from food preparation, such as in restaurants, fast food outlets, food processing plants and the like. Vegetable oils and animal fats and oils are renewable and are potentially an inexhaustible source of energy with an energy content or heat capacity or calorific value close to that of conventional petro-diesel fuel. One way in which waste materials can be converted to fuel or fuel components includes the transesterification of the waste material to form alkyl esters which can be used as the fuel itself or as a component of the fuel such as for example as a fuel additive or in a fuel blend with more conventional fuels, such as petrol, gas, petro-diesel, gasohol, or similar. Fuels containing the transesterified alkyl esters are often referred to as bio-diesel since in many ways the transesterified products can be used as a replacement either directly or indirectly for conventional hydrocarbon diesel which is often referred to as petro-diesel to distinguish it from bio-diesel. One reason that transesterification of vegetable and animal oil and fats is attractive is that the fatty acid esters formed as a result of the transesterification have properties and physical characteristics very close to diesel fuel or can be readily modified to have such characteristics. Additionally, many of the methyl and ethyl esters of fatty acids can be combusted directly in unmodified diesel engines with very low deposit of solid materials or of formation of residues or can be combusted in engines requiring only a small amount of modifications.

In addition to being usable as a substitute fuel for petro-diesel, or other fuels, bio-diesel can be blended with standard petroleum diesel or other fuels in a wide variety of different proportions for use as a composite fuel or similar. Further, bio-diesel is non-toxic, bio degradable, chemically stable and less environmentally hazardous than petro diesel. Bio-diesel can be created from completely renewable sources instead of relying on crude oil or other difficult to find and/or non-renewable sources of petro diesel having finite resources.

One impediment to the wide spread adoption of bio-diesel has been the cost of producing sufficient quantities of bio-diesel at a cost which makes its use economically viable or attractive, and particularly, in providing consistent quality of bio-diesel having low amounts of impurities or contaminants at an economically attractive price. Existing supplies of bio-diesel often have variable amounts of impurities and contaminants which often cause problems in engines and fuel systems such as for example resulting in premature wear and breakdown of rubber seals, connectors for fuel lines and the like. The present invention sets out to address these shortcomings by providing a combined process which not only produces bio-diesel but which also substantially decontaminates the bio-diesel using methods and apparatus which result in the production of low cost bio-diesel substantially free of harmful contaminants so as to be of a quality that is useable as a substitute for petro-diesel, either directly as a substitute fuel or as a blended replacement fuel, particularly in engines such as motor vehicle engines, including compression engines, internal combustion engines or the like.

Therefore, it is the aim of the present invention to provide a method and apparatus which is more effective in producing bio-diesel at a lower price and of a higher quality making the use of the bio-diesel economically feasible as a replacement for petro-diesel as a fuel for motor vehicle engines.

### SUMMARY OF THE INVENTION

According to one aspect of the present invention there is provided a process for producing a fuel or a fuel component manufactured from a raw material using a transesterification process followed by upgrading and/or purifying and/or refining of at least one of the products formed from the raw material in or by the transesterification process, said process comprising reacting the raw material in a transesterification reaction in a processor vessel to form an at least partially converted reaction product and a by-product, said converted reaction product being essentially the or a precursor to the fuel or fuel component and the by-product being one of the contaminants of the fuel or fuel component which requires removal before the converted reaction product can be used as a fuel or fuel component, passing the at least partially converted reaction product and the by-product to a consolidator wherein passage of the converted reaction product and by-product through the consolidator causes the converted reaction product to be consolidated in a first region or in a first flow path within the consolidator and causes the by-product to be consolidated into a second region or into a second flow path within the consolidator to provide consolidation of the converted product and by-product respectively in order to facilitate subsequent separation of the by product from the converted product prior to separation of the by-product from the converted raw material so as to assist in subsequent decontamination of the converted reaction product, and passing the converted reaction product and by-product through at least one separator to at least partially separate the converted product from the by-product to form an essentially upgraded product and separately discharging the upgraded product from the separator and the by-product thereby providing an upgraded product containing a reduced amount of contaminating by-product wherein the upgraded product is or forms the bio-diesel fuel or fuel component.

According to another aspect of the present invention, there is provided a method of separating a first material from a second material to upgrade a raw material so as to improve the economic value of the raw material when used as a fuel or fuel component including the steps of transesterifying the raw material in a processor vessel to form a converted reaction product and a by-product, consolidating the converted reaction product in a first part of a consolidator or into a first flow path within the consolidator and consolidating the by-product within the second part of the consolidator or into a second flow path within the consolidator respectively to enhance the chance of separating the by-product from the converted reaction product in a subsequent process step, and substantially separating the consolidated converted reaction product from the consolidated by-product in a separator to form an upgraded product and separately discharging the essentially upgraded product from the separator at a first location within the separator and discharging the by-product from the separator at a second location within the separator, thereby providing an upgraded product having a reduced amount of contamination by the by-product wherein the upgraded product is the fuel or fuel component or can be formed into the fuel or fuel component.

### BRIEF DESCRIPTION OF THE INVENTION

Typically, the raw material of the present invention can be selected from a wide variety of suitable materials, including waste materials, virgin materials, unused materials, refined materials, recovered materials and the like including combinations of two or more such materials. The raw materials can include materials derived from vegetable and/or animal sources, particularly oils, fats and greases derived from vegetables and animals as appropriate. More typically the waste material is a used vegetable oil or a virgin oil derived from a plant, such as for example, sunflower oil, rapeseed oil, palm oil, cotton, corn, tallow, canola, coconut, soya or the like. Even more typically, the vegetable oil contains a triglyceride or other similar long chain hydrocarbon. Even more typically, the raw material is a waste material, such as for example a waste material derived from food preparation, including restaurants, fast food outlets, or from food processing or the like.

Typically, the raw materials include virgin vegetable oil, straight vegetable oil (SVO), waste vegetable oils (WVO), lard, tallow or the like including mixtures thereof.

Typically, the by-product is glycerin or other glycerin-like contaminants or glycerine-containing contaminants, including glycerols, glycerine, glyceritol, glycyl alcohol or derivatives or precursors. More typically, the contaminants include contaminants such as soap, saponifiables, particulate material, residues, or the like. More typically, the by-product is upgraded, refined, treated, recycled, processed or similar into a more useful product or alternatively the by-product is used to generate energy, such as for example, by being combusted, burnt, being used as a fuel for a burner, boiler or the like for generating power, heat, light or other energy, including providing energy for the engineering plant or installation in which the processes of the present invention are conducted.

If the glycerin by-product can be upgraded to a suitable quality it can be used as a commercial product in a variety of different applications such as for example, in many household products, personal care products, cosmetics, soaps, creams, lotions or the like to further assist in the economic viability of the method and process of the invention. Using they by-product as an energy source in the process of making the bio-diesel in accordance with the present invention, also contributes to the economic viability of operating the manufacturing facility.

Typically, the converted reaction product is the main product of the transesterification reaction. More typically, the converted reaction product is an alkyl ester, particularly a fatty acid alkyl ester, and more particularly an alkyl ester that can be used as a fuel or a fuel component. Most typically, the alkyl ester is a methyl or ethyl fatty acid ester. Preferably, the converted product is bio-diesel or a precursor or derivative of bio-diesel, particularly when the glycerin and soaps have been removed from the esters.

Typically, the transesterification reaction is a catalysed reaction. The reaction can be acid catalysed or alkali catalysed or both. Typically, methanol or ethanol is used. More typically, sodium hydroxide, potassium hydroxide, sodium methoxide NaOCH₃, potassim methode KOCH₃, or the like are used.

Typically, in the transesterification of vegetable oils, a triglyceride reacts with an alcohol in the presence of a strong acid or base or strong acid and base in turn, producing a mixture of fatty acid alkyl esters and glycerol. In one form, the overall process is a sequence of three consecutive and reversible reactions in which di- and mono-glycerides are formed as intermediates. Several aspects influence the extent and type of transesterification reaction, such as for example, the type of catalyst, whether the catalyst is alkaline or acidic, the alcohol used, the raw material being treated, the alcohol/raw material (vegetable oil) molar ratio, the temperature, the pressure of the reaction, the purity of the reactants, the water content, free fatty acid content of the raw material, and other components.

Typically, the upgraded product is the converted product (alkyl ester) from which some contaminant, namely the by-product (glycerin) has been at least partially removed. More typically, the upgraded product can be subjected to a single or multiple upgrade treatments including one, two, three, four or more upgrade treatments with each successive treatments removing glycerin or other by-products or unwanted materials thereby resulting in the upgraded product having greater purity. The upgraded product is the bio-diesel or bio-diesel precursor. Further, in some embodiments, the upgraded product can be used as a bio-diesel fuel without further treatment whilst in other cases the upgraded product requires further treatment before it can be used as a bio-fuel.

More typically, each successive upgrade removes progressively more contaminants from the bio-diesel so as to increase the purity of the bio-diesel.

Typically, the process of the present invention includes a pre treatment step. More typically, the pre treatment step is most likely necessary if waste vegetable oils are being used as the raw material to be converted to bio-diesel. More typically most waste vegetable oils contain large amounts of unwanted contaminants (including water and particulate debris), which requires removal prior to any chemical conversion using the transesterification reaction. Typical methods for removing unwanted materials prior to transesterification, include single step processes or multi-stage processes such as processes involving sedimentation, filtering, boiling and chemical treatment of the waste material.

Typically, the transesterification process is capable of producing from 2 to 10 million litres of upgraded product per month. More typically, the capacity of the processor vessel is about 13,900 litre per hour and about 8,300,000 litres of bio-diesel per month. More typically, up to about 97% conversion of oil to bio-diesel occurs in the process of the present invention. More typically, the process of the present invention includes acid transesterification. If the acid transesterification is incorporated into the overall process as an option, the free fatty acid present in the raw material and/or converted product will be converted back to bio-diesel to give an overall conversion yield of almost 100%.

Typically, there is a single processor or reactor in which the transesterification process occurs. More typically, there are two or more processors or reactors. Typically, there is a single consolidator or two or more consolidators. The processors may be arranged serially or be arranged alternatively with the consolidators.

### BRIEF DESCRIPTION OF THE DRAWINGS

The present invention will now be described by way of example with reference to the accompanying drawings in which:

FIG. 1 is a schematic version of a flow chart of one form of the process of the present invention,

FIG. 2 is a schematic version of a flow chart of an alternative form of the process of the present invention.

### DETAILED DESCRIPTION OF THE INVENTION

### Example 1

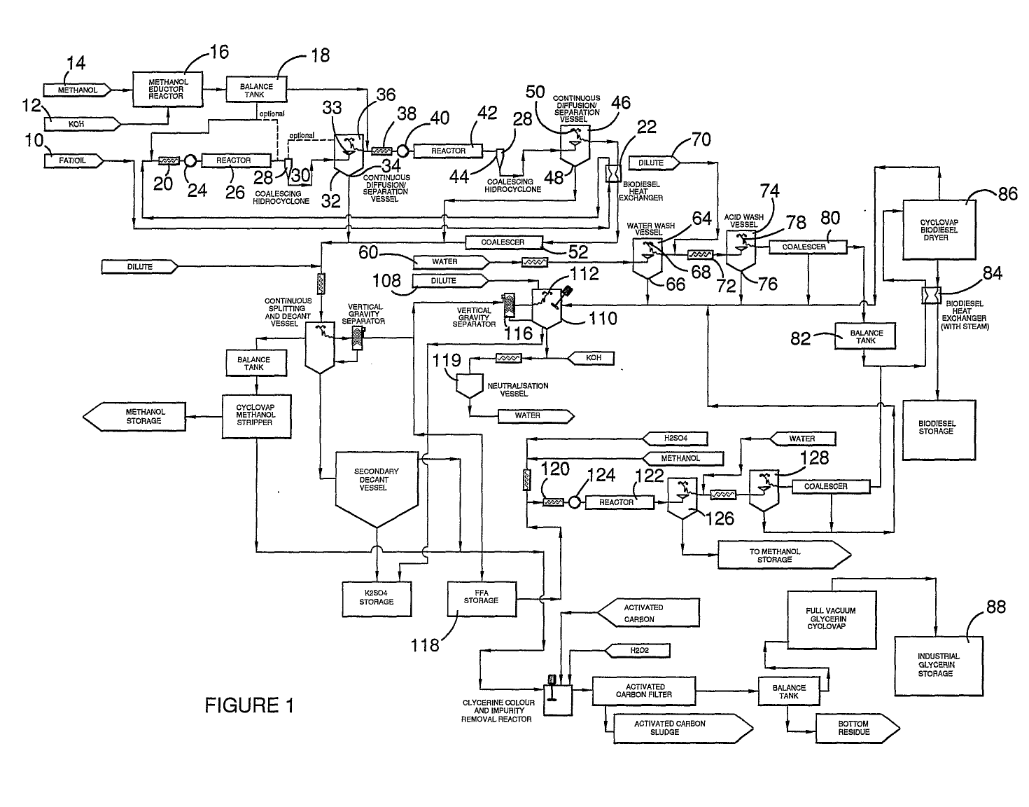

The overall process of one embodiment of the method and apparatus of the present invention will now be described with particular reference to FIG. 1.

The raw material is in the form of fat, oil and grease, particularly vegetable oil and animal fat or tallow derived from food preparation such as in restaurants or fast food outlets or in food processing such as manufacturing packaged foods, is stored in waste material storage tank 10. Typically, the free fatty acid content of the waste material being stored in tank 10 is preferably less than 5%, but can be up to 20%, typically 5 to 10% depending upon the specific reaction conditions used in the process of the present invention such as for example, whether acid transesterification is to be used. However, any free fatty acid content within reasonable limits can be treated by the process of this invention even if an optional pre-treatment stage is necessary. One advantage of the process of this invention is that raw material, including waste material containing higher percentages of free fatty acid can be treated since existing processes can only tolerate low levels of free fatty acid. Optionally, a pre treatment tank 8 is provided in fluid communication with waste storage tank 10 in which the pre treatment of the waste material can take place to remove some of the unwanted materials and particulate material from the waste material, such as for example, by filtering, sedimentation, skimming, boiling or the like. Alternatively, the pre-treatment can be done elsewhere and the pre-treated waste transported to the installation in which the bio-diesel in accordance with the present invention is manufactured for storage in tank 8 or 10. Alkaline storage tank 12 is provided for storing an alkaline material for catalysing the transesterification reaction. In one example the alkaline material is potassium hydroxide. Other examples of the alkaline catalyst are also usable, such as for example sodium hydroxide or similar. Also, it is to be noted that the catalyst, KOH in this case, can be mixed directly with the alcohol prior to the transesterification reaction taking place, such as for example by mixing KOH from individual bulk bags with the methanol. In this embodiment the separate storage tank 12 is not needed. It is to be noted that acid catalysis can be used for the transesterification reaction. Additionally, it is possible to have both a combined alkaline catalysed transesterification reaction and an acid catalysed transesterification reaction, such as for example, in a two stage procedure involving an acid catalysed transesterification first stage and an alkaline catalysed transesterification second stage, sometimes referred to as a push-pull reaction. Such two-stage reactions are often used with raw materials having a high free fatty acid content. Alternatively, there can be double or multiple acid or base catalysed stages, including mixed catalyst stages depending upon circumstances. It is to be noted that any suitable form of alkaline or acid may be used in the process of the present invention.

Methanol storage tank 14 is provided to store methanol for use in the transesterification reaction. Other alcohols, such as ethanol, propanol or similar higher alcohols could be used as well as other sources of the alkyl group for making the alkyl esters in the transesterification reaction. Alternatively, sources of the alkyl group other than alcohols can be used such as methoxides, ethoxides, and anhydrous methyl alcohol, or the like.

A methanol eductor reactor 16 is provided for receiving methanol from methanol storage tank 14 and potassium hydroxide from alkaline storage tank 12. In one form the eductor reactor utilises a venturi eductor to mix the potassium hydroxide into the methanol in a pre defined ratio dependent upon the amount of free fatty acid present in the waste material stored in storage tank 10 that is to be subject to the transesterification reaction. In one form the operator only has to load a bulk bag of KOH onto a weight scale hopper when empty. The operator does not have any contact with the alkaline material using the eductor. In this embodiment, it may not be necessary to have separate storage tank 12 for the alkaline material. The mixture formed in the eductor can be a slurry, paste, solution or similar and the eductor is operated to provide a predetermined ratio of alcohol to alkaline. The alkaline material can be any suitable material, such as for example, potassium methoxide (CH₃0K). The mixture is conveyed from the eductor to balance tank 18 which is pressurised to a positive pressure of up to about 50 psi more typically up to about 150 psi or the like. In one form, the balance tank is provided with one outlet for conveying the mixture to mixer 20 whereas in another form balance tank 18 is provided with two outlets in which about 80% of the mixture is conveyed to mixer 20 and 20% is conveyed to a further mixer 38 which will be described in more detail later.

It is to be noted that the 80/20 split of discharge from balance tanker 18 is optional. Other variations are possible, including other variations of the location of the conduit from balance tank 18 to the reactor or reactors of the installation and to where the conduit joins with the other conduits within the installation are possible.

The waste material containing the vegetable oil and fat is heated to about 65° C. and piped to heat exchanger 22 where it is heated to about 80° C. for piping to mixer 20 at a temperature of between about 70° C. to 80° C. for mixing with the mixture from balance tank 18. In one form mixer 20 is a static mixer. Any suitable mixer can be used.

The mixture is then pumped from static mixer 20 using high pressure pump 24 to a first processing vessel 26.

In one configuration, the feed from balance tank 18 is located upstream of static mixer 20 whereas in other configurations, the feed from balance tank 18 is located downstream of pump 24. It is preferred that the mixture from balance tank 18 be admitted downstream of pump 24 and that the mixture be liquid since it is easier to mix with the raw material. Also, adding the mixture after tank 18 and after heating of the incoming raw material, allows easier mixing when warm without there being a substantial chance of vaporisation in pump 24.

In one form processing vessel 26 is a modular processor or reactor of the type having a multitude of interchangeable tubes which can be assembled in a number of different configurations to provide variable path length for the reactants to flow through the processor to provide sufficient residence time within the reactor to enable the reactants to react with each other in the transesterification reaction in accordance with the composition of the waste material being treated and the properties of the bio-diesel required and the operating conditions of the processor. As an example, the number of interchangeable tubes that are joined together to alter the length of the processor 26 is dependent upon the free fatty acid content of the waste material to produce a bio-diesel containing only trace amounts of impurities. Other operating conditions also influence the size of processor 26.

In one form the modular processor 26 is a plug flow processor of the type made from chemical resistant and high pressure materials or a processor capable of operating under plug flow conditions. However, in some embodiments which are less preferred other processor vessels may be used such as for example continuous stir tank vessels (CSTR). However, in such circumstances the CSTR vessels are required to be made from exotic and expensive materials to preserve the required properties of the bio-diesel. It is noted that it is preferred to use a continuous processor vessel in the interests of economy of operation and consistency of quality of the bio-diesel. However, any suitable continuous processor can be used.

In one embodiment pressure pump 24 operates from about 3000 psi upwards, typically from about 3000 psi to about 4000 psi, typically around about 3000 psi to provide sufficient pressure to force reactants through the processor 26 and through the subsequent processing stages to produce the upgraded bio-diesel. Using high to very high pressure and subsequent gravity feed obviates the need to use suction to transport the various materials from the processor 26 for subsequent treatments or processing thus avoiding the problems associated with suction, including emulsification of the materials or the like.

In one embodiment, the conduit from balance tank 18 is joined to the conduit leading to the inlet of reactor 26 so that methanol mixture can be introduced into the reactor downstream of pump 24 rather than upstream of pump 24 which assists in the efficiency of operation of the installation.

In the modular processor, transesterification takes place to produce alkyl esters, typically methyl alkyl esters i.e. the converted product, when methanol is used or ethyl alkyl esters if ethanol is used as the alcohol. It is to be noted that any suitable alkyl ester can be formed. However, it is most preferred that methyl alkyl esters are formed. The esters formed are examples of the converted reaction product formed by reaction of the raw material, particularly waste material. By products are also formed in the transesterification reaction in addition to the formation of the alkyl esters. One example of the by-product is glycerin. Glycerin is usually referred to as the impure form of glyceryl and alcohol. The term glycerin will be used to refer to any by-product whether it is glycerin or related to glycerin, is glycerine or triglyceride or triglycerine or similar. The term glycerin as used herein refers generically to almost all types of contaminants or impurities produced in the transesterification reaction that takes place in processor 26.

The mixture of ester and glycerine is discharged from modular processor 26 at a pressure of about 150 psi where it is piped to a first consolidator 28. One form of the consolidator is a separator, more typically a first separator 28. Preferably, the first separator is in the form of a hydrocyclone, more particularly a coalescing hydrocyclone in which the mixture of ester and glycerin is swirled so as to form two separate flow paths at different locations within the hydrocyclone so as to coalesce the droplets of ester into larger droplets of ester in one flow path or one part of the consolidator and to coalesce separately the droplets or particles of glycerin into larger droplets or particles of glycerin in another flow parth or part of the consolidator. The coalescing hydrocyclone is used to precondition the glycerin and ester for subsequent separation on the basis of the different densities of each allowing the heavier material to be collected around the sides of the hydrocyclone i.e. in one flow path or part of the hydrocyclone and the lighter material to form a central core or plug along the central axis of the hydrocyclone i.e. in the other flow path or part of the hydrocyclone. This preliminary consolidation pre-conditions the products of the transesterification reaction to enhance their subsequent separation by concentrating the droplets of the respective materials into the two streams.

It is to be noted that the main function or primary purpose of the consolidator is to increase the droplet size of the by-product and ester, respectively to assist in their subsequent separation from each other and not to actually separate the two materials from each other although some separation will occur in the consolidator. The pre-conditioning or preliminary separation allows a shorter time for separation of the glycerin from the ester in subsequent separation processes. It is to be noted that passing the ester and glycerin through the hydrocyclone does not necessarily separate the two components from each other but merely alters the form or state of the two components so that they can be more readily separated during subsequent processing. It has been observed that in some embodiments of the invention, making some forms of the bio-diesel fuel component using the consolidator, can reduce the time taken in the separator to separate the by product from the bio-diesel component from about 8 hours to about 3½-4 hours which has the effect of being able to reduce the size of separator 32 thereby saving costs in both installation of the plant and in operating costs running the plant.

In one embodiment hydrocyclone 28 has a single discharge outlet 30 connected to a first separator 32 whereas in other embodiments hydrocyclone 28 has two discharge outlets. In embodiments having two discharge outlets up to about 90% of the transesterified mixture is discharged from the top of hydrocyclone 28 for admission at the three quarter level of separator 32 which is located generally about three quarters of the way along the side wall of hydrocyclone 32 towards the top of the hydrocyclone, and 10% of the transesterified mixture is admitted to the one third level of separator 32 which is located generally about a third along the side wall of hydrocyclone 32. In the embodiment illustrated in FIG. 1 there is shown a single outlet 30 connected to about the one third level of separator 32. Other variations are possible.

The converted ester waste product and glycerin (the by-product) are conveyed from outlet 30 of hydrocyclone 28 to separator 32. In one form separator 32 is a sedimentation separator in which the more dense glycerin accumulates at or towards the base of separator 32 and the less dense ester accumulates at or towards the top of separator 32. A diffuser 33 is provided internally within the body of separator 32, typically in the mid to upper portion of separator 32, for diffusing the entry of the ester and glycerin into the separator 32 to further enhance or increase the separation of the ester and glycerin from each other by spreading the incoming mixture over a larger surface area. It is preferred that the converted waste product be introduced into separator 32 tangentially so as to minimise disturbance in the separator by inducing a slow rotation of the contents in separator 32.

Separator 32 is provided with outlet 34 for discharging glycerin for subsequent processing which will be described in more detail later in this specification. It is to be noted that about 80% of the glycerin produced in the transesterification reaction is separated from the ester in separator 32 so that very little if any ester is discharged through outlet 34 along with the glycerin. However, the ester in separator 32 contains an amount of glycerin.

An overflow skimmer arrangement 36 is provided out or towards the top of separator 32 to allow the ester to be discharged from separator 32 for conveying to a second mixer 38 which is located downstream of separator 32. Second mixer 38 is also a static mixer. In one embodiment 20% of the alcohol from balance tank 18 is added to mixer 38 whereas in another embodiment only the upgraded ester from overflow skimmer 36 is admitted to mixer 38. A second high pressure pump 40 is provided between the outlet of mixer 38 and the inlet of a second modular process vessel or reactor 42 acting as a polisher vessel.

Pressure pump 40 operates generally at a pressure greater than about 3000 psi. However, it can operate at between about 1500 to 3000 psi if conditions require. Generally, it will operate at about 3000 to 4000 psi.

Second modular polisher vessel 42 is also a plug flow processor of the modular type having inter-changeable or replaceable reactor tubes for varying the length of the reactor to accommodate the different properties of the upgraded ester received from separator 32 by providing sufficient residence time for the reaction to take place. Vessel 42 is referred to as a “polisher” because additional transesterification can take place in this vessel to convert more of the vegetable oil to ester or to increase the yield of the overall reaction. If required additional alcohol and alkaline material can be added to reactor 42 to assist in the transesterification reaction.

A second consolidator in the form of a hydrocyclone, typically a coalescing hydrocyclone 44, is connected to the outlet of reactor 42. Hydrocyclone 44 is a coalescing hydrocyclone and operates in the same manner as hydrocyclone 28 so that the same considerations as described previously with respect to hydrocyclone 28 also apply to hydrocyclone 44. Hydrocyclone 44 is provided with a single outlet or optionally with two outlets. Upgraded material from coalescing hydrocyclone 44 is piped to second separator 46 for further separation of the glycerin from the ester to improve the purity of the ester. Separator 46 is a similar separator to separator 32 and allows glycerin that is almost free of ester to be discharged from outlet 48 and for upgraded ester that is substantially free from glycerin to be discharged from separator 46. The upgraded ester is discharged through overflow skimmer 50 to heat exchanger 22 for cooling from about 85° C. to 65° C. by passage through heat exchanger 22. It is to be noted that at this stage, although almost all of the glycerin has been removed from the ester, it is possible that the ester can still contain residual contaminants and other impurities such as unreacted alkaline or alcohol or other unreacted materials, soaps, catalysts, potassium sulphate, or other unwanted reaction products or by-products, or the like.

Upgraded ester is conveyed from heat exchanger 22 to coalescer 52. Coalescer 52 is a conventional coalescer for removing residual material from the ester.

Water from water storage vessel 60 is introduced to a third mixer such as static mixer 62 together with the ester bio-diesel from coalescer 52 to wash the ester. It is to be noted that washing of the ester removes unwanted material rendering the ester more suitable for use as bio-diesel in an engine. The washed bio-diesel is introduced to a third separator 64 for separation of the bio-diesel and soap formed from the residual impurities contained in the ester. Although the residual material separated from the ester is referred to as soap it is to be noted that this is a general term and is not meant to be limiting of the type of materials separated in separator 64. Soaps can include salts, potassium sulphate, etc and other saponifiable materials. Soap is discharged from separator 64 through outlet 66 for conveying to suitable apparatus for further processing and treatment that will be described later.

The upgraded ester is removed from separator 64 through overflow skimmer 68 and conveyed to a further mixer 70 where it is mixed with acid such as for example sulphuric acid, more typically diluted sulphuric acid to acid wash the ester. The acid wash removes residual impurities of the type referred to as soap. This acid washed mixture is passed to a further separator 74 where the soap is removed from the base of separator 74 and the further refined or upgraded ester is discharged through overflow skimmer 78 where it is passed to a further coalescer 80 to remove any residual material. Coalescer 80 may be a conventional coalescer or any suitable type of coalescer. The substantially pure ester forming the bio-diesel is discharged from coalescer 80 to a balance tank 82 acting as a reservoir for the purified ester. Any residual material remaining in the upgraded bio-diesel (now substantially purified bio-diesel) includes water and methanol. The bio-diesel is passed through heat exchanger 84 to heat the bio-diesel to a temperature of about 80 degrees for admission to drier 86. Residual water, methanol and other volatiles are removed from the bio-diesel in drier 86. In one form drier 86 is a cyclonic evaporator. The dried pure bio-diesel is removed from evaporator 86 and passed through heat exchanger 84 to reduce its temperature from about 85 degrees to 65 degrees where it is conveyed to bio-diesel storage vessel 88 as the finished product. Volatiles from the ester are removed from evaporator 86 and are further processed and treated, including to be reused or recycled in the installation of the present invention or to be processed into another product or similar.

Many modifications and changes can be made to the apparatus and installation of the present invention without departing from the spirit and scope of the present invention. Modified forms of the process and apparatus of the present invention will now be described.

In addition to the alkaline catalysed transesterification reaction which occurs in processor 20 and subsequent polisher 42 or mixers as previously described the modification of this embodiment includes acid transesterification, particularly acid transesterification of any fats, oils, greases and free fatty acid not esterified in the alkaline reaction. The soap residues from separators 64, 74 and evaporator 86 are conveyed to a further mixer tank 110 for mixing with acid, typically sulphuric acid such as diluted sulphuric acid from acid storage tank or supply 108 to further treat the soap materials such as for example, to split the soap waste. The soap waste containing free fatty acid or useful waste material convertible to esters is discharged from mixer 110 through overflow skimmer 112 and admitted to vertical gravity separator 116 in which the organic materials are separated from water. The organic materials containing free fatty acid are piped to a suitable storage vessel 118.

Waste water from mixer 110 is neutralised in neutraliser tank 119 with alkaline and treated enabling this water to be reused or to be discharged to waste.

The recovered free fatty acid from storage 118 is mixed with alcohol and acid in mixer 120 and pumped through modular processor 122 by high pressure pump 124 to separator 126 in which the bio-diesel component is separated from methanol. The methanol is recycled to a suitable methanol storage such as methanol storage tank 14 and the bio-diesel washed and separated in separator 128 for mixing with the bio-diesel from balance tank 82 prior to admission to the cyclovap drier 86 and final storage 88.

The glycerin material is further treated by being washed, neutralised, bleached and stored ready for use using conventional methods and apparatus, such as for example, bleaching with hydrogen peroxide, filtering with activated carbon and the like.

Further modifications of the apparatus and method of the present invention include the following.

### By-Product Removal System

The glycerin and soap by-products are removed from the bio-diesel by settling in specially designed settling vessels. The settling rate is enhanced by the use of coalescing devices.

### Bio-Diesel Washing System

The bio-diesel contains traces of alkali materials and soap products after emerging from the reactor or reactors. These materials are removed from the bio-diesel in two washing steps. Finally, the bio-diesel is dried in a cyclovap evaporation system to remove any residual water and methanol that can effect the flash point of the bio-diesel.

### Glycerin Processing System

The crude glycerin formed in the bio-diesel reaction is removed from the settling vessel and reacted with diluted sulfuric acid to split the Free Fatty Acid (FFA) from the crude glycerin. Potassium sulfate is removed by decanting from the vessel as a slurry. The slurry is passed to another decant tank for further dewatering. The glycerin has methanol removed by passing through a cyclovap evaporation system under vacuum. The glycerin is then further refined by reacting the impurities out of the glycerin using hydrogen peroxide and removing the colouring agents using activated carbon. Both operations occur in a specially designed mixing vessel. The glycerin is then filtered in a special filter to remove the activated carbon and impurities to leave a clean, clear glycerin product that can be further purified if required.

### Further Acid Esterification

If required, the FFA removed from the glycerin and washwater phases can be passed through another processor operated in accordance with the present invention, with the addition of methanol and acid catalyst to generate further bio-diesel and increase yield. In some cases, the FFA can be sold as a separate by-product without the need for further processing into bio-diesel.

### Example 2

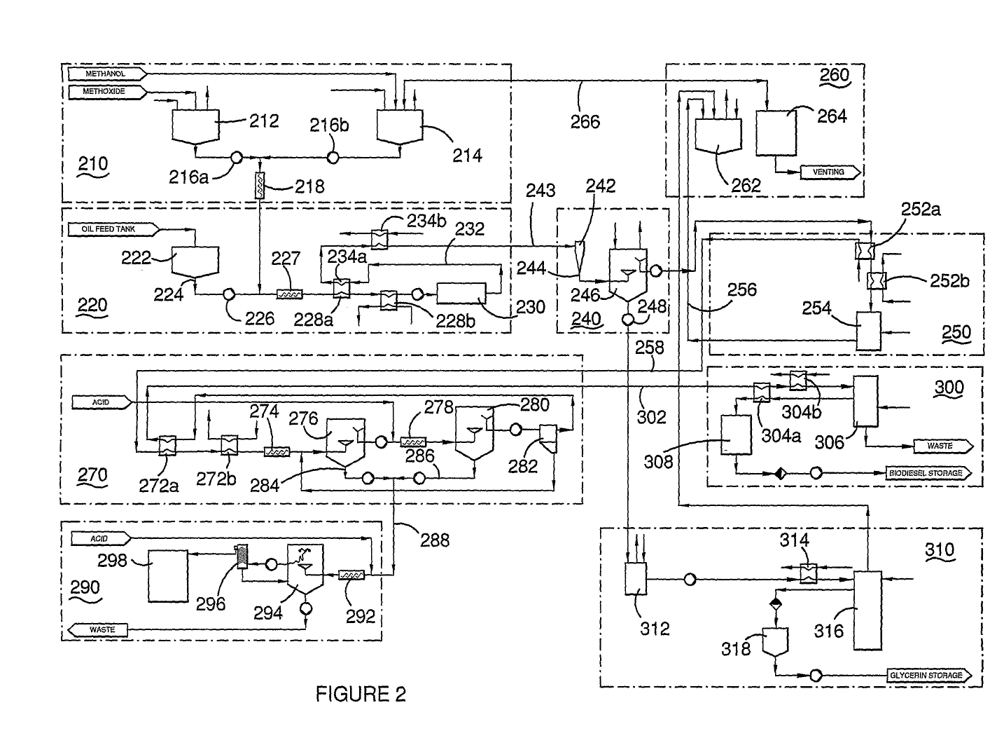

The present invention will now be described with particular reference to FIG. 2.

The embodiment shown in FIG. 2 is an alternative to the installation in which the process of the present invention is carried out as described with reference to FIG. 1.

In this embodiment, the installation (and flow chart) is divided into a number of separate stages, units or assemblies representing different parts of the installation and/or different stages in the overall process.

### Methanol Supply Stage.

One stage of this installation is the methanol supply stage, generally denoted as 210. In this stage, fresh or previously unused methanol is stored in methanol storage tank 212 whereas recycled or recovered methanol is stored in methanol recovery tank 214. Outlets from tanks 212, 214 are provided with pumps 216a, 216b and are combined together before entering static mixer 218 for conveying the methanol to the next stage which is the raw material supply stage 220. Fresh methanol or a blend of fresh methanol with recovered methanol can be used as required. One form of the raw material is waste oil. However, the raw material may be of any suitable type including virgin oil material or a combination of materials. The oil forming the raw material is stored in oil storage tank 222 having a conduit 224 connected to the outlet of tank 232 and provided with a suitable pump 226. Methanol supplied to conduit 224 from methanol mixer 218 is mixed with oil from oil storage tank 222 in static mixer 227 and passed through one or more heat exchanges 228a, 228b to processor or reactor 230 in which the transesterification reaction in accordance with the present invention takes place to produce an ester containing component and a by-product component which are discharged in combination from processor 230 through conduit 232 to heat exchangers 234a, 234b for introduction to coalescing hydrocyclone 242 forming part of separation stage 240 of the embodiment illustrated in FIG. 2.

Similar to hydrocyclone 30 of FIG. 1, hydrocyclone 242 has a single inlet 243 but is provided with either a single outlet 244 as shown in FIG. 2 or optionally two outlets (not shown). The outlet 244 of hydrocyclone 242 is provided with a conduit leading to separator 246 for separating ester (converted reaction product) from by-product (glycerin) in a similar manner to that described with reference to the corresponding separator 32 used in the process and installation as described with reference to FIG. 1.

It is to be noted that further separation stages including additional reactors, consolidators and separators can be included optionally in this embodiment depending upon requirements.

The converted or upgraded reaction product containing amounts of methanol separated in separator 246 (or in subsequent separation stages) is removed from separator 246 through conduit 248 to the methanol recovery stage 250 in which methanol is removed from the ester component. The methanol containing ester component is passed through heat exchangers 252a, 252b before being introduced into separator 254 in which the methanol is removed from the upgraded ester product. The removed methanol is piped through conduit 256 to methanol distillation stage 260 for recovery of methanol. Methanol distillation stage 260 includes a methanol storage tank 262 for accumulating a supply of methanol and a methanol distillation column 264 in which methanol is recovered. The methanol recovered in distillation column 264 is transferred to methanol recovery tank 214 of stage 210 through conduit 266 for future use.

The upgraded reaction product containing esters from stage 250 is transferred via conduit 258 to a water and acid washing stage 270 for washing the ester component. The water and acid wash stage is similar to the corresponding stage of FIG. 1. The ester component, after passing through heat exchangers 272a, 272b, is passed through static mixer 274 where it is mixed with water recovered from the previous water washes to form a wash mixture. The wash mixture is passed to water wash separator 276 where water is removed from the ester containing component and the ester containing component is passed to a mixer, in the form of a static mixer 278, where it is mixed with an acid, such as for example, sulphuric acid, to form an acid wash mixture before being passed to a separator 280 for removing further impurities from the ester containing component. The water washed and acid washed ester component is passed to a coalescer 282 where water is removed from the ester component in the form of bio-diesel. The water removed from the bio-diesel is recycled for use in washing further incoming ester containing component to remove impurities.

The residues removed from water wash separator 276 in conduit 284 and acid wash separator 280 in conduit 286 both containing the impurities are combined together into a single conduit 288 and transferred to a soap splitting stage 290 using conduit 288 where the residue stream is mixed with sulphuric acid in static mixer 292 to split soap and other residues from the residue component so as to recover Free Fatty Acid. The mixture is passed to soapy water separator 294 where waste residue is removed from the water component. The water component from the separator is passed to a further separator in the form of a vertical gravity separator 296 where any residual Free Fatty Acid is removed from the water and stored in FFA storage tank 298.

The washed refined bio-diesel from coalescer 282 of stage 270 is transferred via conduit 302 and heat exchangers 304a, 304b to bio-diesel drying stage 300 where the bio-diesel is dried by removing any residual water in cyclo-evaporator 306. The dried bio-diesel is stored in bio-diesel storage tank 308 ready for use, transportation or the like and the removed water either recycled or discharged to waste.

The glycerin removed from separator 246 of stage 240 is pumped to glycerin treatment stage 310 comprising glycerin storage tank 312 acting as a reservoir via heat exchanger 314 to glycerin drier 316 where water is removed from the glycerin. The dried glycerin is pumped from drier 316 to glycerin balance tank 318 for storage prior to reuse. One application of the recovered glycerin is for use as a fuel in the boiler incorporated into the installation in which the process of the present invention is carried out, such as for example, to heat water, including recovered water to form stream, hot water or the like, including providing heat to one or more of the heat exchangers.

### ADVANTAGES OF THE INVENTION

The significant advantages of the process and apparatus of the present invention over existing bio-diesel processing plants include the following:

By incorporating a consolidator between the processor or reactor and the separator more efficient separation of the desired product, bio-diesel ester material, from the by-product can be attained since the consolidator consolidates the two groups of products into a form, such as for example, longer droplet size materials, that allows subsequent easier separation in the separator since the larger size droplets are easier to separate that small size droplets.

Continuous Process:
The present invention utilises a small plug flow processor made from chemical resistant and high pressure materials rather than a large continuous stir tank processor (CSTR) made from exotic and expensive materials.

Suction Pressure:
The use of a continuous processor removes the need to have suction pressure on vessels for methanol recovery.

Smaller Evaporator Size:
Use of a cyclovap type evaporator or similar for glycerin and bio-diesel are much smaller than conventional evaporators due to the extremely high heat transfer coefficient of the cyclovap evaporator.

Fewer process vessels:
Fewer process vessels are required for intermediate products as the method of the present invention results in an improvement in the combination of high pressure processors and settling vessels for rapid separation.

Increased capacity capability:
Capacity can be increased by adding extra processors to form processor modules or trains without the need to add proportional numbers of extra vessels made from expensive exotic materials.

Operating Flexibility:
Flexibility to operate concurrent processors through parallel trains.

Continuous Processing:
Continuous processing ensures consistent bio-diesel quality. Batch processing can lead to quality variations.

Isolation of Hazardous and Safe Zones:
Isolation of hazardous and safe zones ensure only critical pumps and instruments need to be explosion proof.

More economical:
Bio-diesel can be made more economically with more uniform properties and constant purity allowing the bio-diesel to be used commercially in vehicles.

It is to be understood that, if any prior art publication is referred to herein, such reference does not constitute an admission that the publication forms a part of the common general knowledge in the art, in Australia or any other country.

It will be understood to persons skilled in the art of the invention that many modifications may be made without departing from the spirit and scope of the invention.

1. A process for producing a fuel or a fuel component manufactured from a raw material using a transesterification process followed by upgrading and/or purifying and/or refining and/or post treating of at least one of the products formed from the raw material in or by the transesterification process characterised in that the process comprises reacting the raw material in transesterification reaction in the processor vessel to form an at least partially converted reaction product and a by-product, the converted reaction product being essentially the, or a precursor to, the fuel or fuel component of the bio-diesel and the by-product being one of the contaminants of the fuel or fuel component which requires removal before the converted reaction product can be used as a fuel or fuel component, passing the at least partially converted product and the by-product to a consolidator wherein passage of the converted reaction product and by-product through the consolidator causes the converted reaction product to be consolidated in a first region or in a first flow path within the consolidator and causes the by-product to be consolidated in a second region or into a second flow path within the consolidator to provide consolidation of the converted product and by-product respectively to assist in subsequent separation of the by-product from the converted raw material so as to assist in subsequent decontamination of the converted reaction product, and passing the converted reaction product, and passing the converted reaction product and by-product through at least one separator to at least partially separate the converted product from the by-product to form an essentially upgraded product and separately discharging the upgraded product from the separator and the by-product thereby providing an upgraded product containing a contaminating by-product wherein the upgraded product is or forms a bio-diesel fuel or fuel component.

2. A method of separating a first material from a second material to upgrade a raw material so as to improve the economic value of the raw material when used as a fuel or fuel component characterised in that the method includes the step transesterifying the raw material to form a converted reaction product and a by-product, consolidating the converted reaction product in a first part or within a first flow part within the consolidator and consolidating the by-product within a second part of the consolidator or into a second flow path within the consolidator respectively to enhance the chance of separating the by-product from the converted reaction product in a subsequent separation step, and substantially separating the consolidated converted reaction product from the consolidated by-product in a separator to form an upgraded product and separately discharging the essentially upgraded product from the separator at a first location within the separator and discharging the by-product from the separator at a second location within the separator thereby providing an upgraded product having a reduced amount of contamination by the by-product wherein the upgraded product is the fuel or fuel component or can be formed into the fuel or fuel component.

3. An apparatus or method according to any preceding claim characterised in the raw material is waste material, virgin material, unused material, refined material, recovered material, recycled material, blended material or combinations or two or more such materials.

4. An apparatus or method according to any preceding claim in which the raw material is vegetable and/or animal derived product including oils, fats and greases derived from vegetable and/or animals including vegetable oil such as sunflower oil, rapeseed oil, palm oil, cotton, corn, tallow, canola, coconut, soya or the like.

5. An apparatus or method according to any preceding claim characterised in that the converted reaction product includes a triglyceride or other similar long chain hydrocarbon.

6. An apparatus or method according to any preceding claim characterised in that the by-product is glycerin or glycerin-containing material or glycerin-like material including glycerols, glycerine, glyceritol, glycyl alcohol or derivatives or precursors including combinations of two or more.

7. An apparatus or method according to any preceding claim characterised in that the contaminants include soap, saponifiables, particulate material, residues, unreacted materials, catalysts, soaps, alcohols, and the like.

8. An apparatus or method according to any preceding claim characterised in that the converted reaction product is the main product of the transesterification reaction and includes alkyl esters, preferably a fatty acid alkyl ester such as methyl or ethyl fatty acid ester.

9. An apparatus or method according to any preceding claim characterised in that the converted reaction product is bio-diesel, a precursor for or a derivative of bio-diesel or a material that can be used with or without further treatment as a bio-diesel.

10. An apparatus or method according to any preceding claim characterised in that the transesterification reaction is an alkali catalysed reaction, an acid catalysed reaction or a alkali and acid catalysed reaction in any order.

11. An apparatus or method according to any preceding claim characterised in that there is a single reactor, consolidator and separator, two processors, consolidators and separators or multiple processors, consolidators and separators either arranged serially or alternate or in any order or combination.

12. An apparatus or method according to any preceding claim characterised in that the raw material to be transesterified contains up 20% fatty acid.

13. An apparatus or method according to any preceding claim characterised in that the processor is a modular processor comprising a multitude of interchangeable tubes which can be assembled in a number of different configurations to provide variable path length flow paths for the reactants to follow when passing through the processor to provide sufficient residence time within the processor to enable the reactants to react with each other in the transesterification reaction to form the converted reaction product.

14. An apparatus or method according to any preceding claim characterised in that the converted reaction product is a alkyl ester such as a methyl alkyl ester or ethyl alkyl ester.

15. An apparatus or method according to any preceding claim characterised in that the consolidator is a hydrocyclone, coalescing hydrocyclone, or other similar device.

16. An apparatus or method according to any preceding claim characterised in that the separator is a sedimentation separator optionally provided with a diffuser.

17. An apparatus or method according to any preceding claim in which the converted reaction product or upgraded product is water washed and acid washed to remove unwanted material so as to provide a bio-diesel or bio-diesel component.

18. An apparatus for producing bio-diesel or bio-diesel fuel component substantially as hereinbefore described with reference to the accompanying drawings.

19. A method for producing bio-diesel or bio-diesel fuel component substantially as hereinbefore described with reference to the accompanying drawings.

20. An apparatus for producing bio-diesel or bio-diesel fuel component substantially as hereinbefore described with reference to any one of the foregoing examples.

21. A method for producing bio-diesel or bio-diesel fuel component substantially as hereinbefore described with reference to any one of the foregoing examples.
